(19) United States
(12) Patent Application Publication
(10) Pub. No.: US 2009/0318266 A1
(43) Pub. Date: Dec. 24, 2009

(54) Safety Brake

(76) Inventors: Udo Meller, Wermelskirchen (DE); Gerhard Radoczai, Dornbirn (AT)

Correspondence Address: Scott R. Foster;Pandiscio & Pandiscio, 470 Totten Pond Road, Waltham, MA, 02451-1914, US

(21) Appl. No.: 12/225,611

(22) PCT Filed: Mar. 29, 2007
(86) PCT No.: PCT/EP2007/002781

§ 371 Date: Mar. 9, 2009

(30) Foreign Application Priority Data
Apr. 6, 2006 (DE) 10 2006 016 611.6

(51) Int. Cl. F16D 59/02

(52) U.S. Cl. 477/199

(57) ABSTRACT

The present invention relates to a safety brake (1) having a coupling piece (4) which can move between the brake rotor (3) and the brake stator (2) and is held stably in each case in predefined end positions, wherein the coupling piece is held in an end position which is denoted as a release position (7) by a ferromagnetic permanent magnet (9), counter to the force of a preloading spring (5).

The present invention is directed to a safety brake according to the preamble of the main claim.

Such safety brakes are known. See, for example, www.ortlinghaus.com.

In such safety brakes, a coupling piece is slid between a brake stator affixed to the machine frame and a brake rotor movably mounted inside the rotor.

The coupling piece is mounted non-rotationally-entrainably on the brake rotor or the brake stator within the possible slide path, and engages in a suitable manner in a matingly configured region of the brake stator or the brake rotor, as the case may be, when the coupling piece is slid into the braking position.

Without limiting the invention, it will be assumed below, in order to simplify the description, that the coupling piece is mounted slidably and non-rotationally-entrainably on the brake stator and engages form-lockingly in a mating region of the brake rotor when the coupling piece is in the braking position.

The coupling piece is therefore in constant non-rotationally-entrainable, form-locking contact with the brake stator regardless of the slide position it currently occupies, whereas non-rotationally-entrainable form-locking contact with the brake rotor exists only when the coupling piece is in the braking position.

Then, and only then, does an absolutely rotationally fixed, form-locking connection exist between the brake rotor and the brake stator.

A so-called safety brake is additionally provided in the present case.

This is to be understood as meaning that when the brake is not being supplied with air, the coupling piece is positively displaced into the braking position by a defined spring preload, and goes to the release position only as a result of the active actuation of an air delivery system.

Such safety brakes are used in many sectors of industry.

They serve the purpose, in a given technical application, of forcibly bringing about a braking effect that occurs in one of the two end positions of the coupling piece and can be canceled only actively, by means of externally activated force generators.

Such force generators can be, for example, hydraulically actuated piston/cylinder units, which are supplied with air to release the brake and on losing pressure are overpowered by the spring preload, causing the safety brake to positively close.

The hydraulics for safety brakes of this kind tend to entail considerable expenditure, whereas it is desirable for such a safety brake to be of simplified construction and also for it to be held unequivocally and securely in its end position, denoted as the release position, in which the coupling piece is at the opposite end of its slide path from the braking position.

It is, therefore, an object of the present invention to develop the safety brake in such a way that, despite simplified construction, the coupling piece is held unequivocally in an end position in which the brake is supplied with air and nevertheless can easily be released from that position as soon as the safety function is needed.

The invention achieves this object by means of the features of the main claim.

The invention provides the advantage that the safety function can be made operative only by canceling the holding force exerted on the coupling piece in the release position.

As the safety function becomes operative, the preload force of the preload spring becomes the predominant force acting on the coupling piece and the safety function is positively achieved.

The holding force of the holding force generator is therefore usefully defined such that, given the forces and accelerations that occur during normal operation, the coupling piece is held securely in the end position denoted as the release position.

If, however, the holding force either is canceled for only a short time or is overcome by an oppositely directed locking force, the system of preload springs goes into action and displaces the coupling piece safely into the braking position.

The invention therefore provides a safety brake having two defined end positions and in which the coupling piece moving between the brake rotor and the brake stator is held stably in each of said end positions.

A safety brake with bistable end function is obtained in this way. The magnetic holding force generator can be, for example, an electromagnet.

A ferromagnetic permanent magnet is preferred, however, since it requires no energy input of any kind.

To be able to work exclusively with small-sized magnetic holding force generators right from the start, it is supplementarily proposed that in the end position denoted as the release position, the coupling piece contactingly abuts a holding surface that is present on the brake stator and through which the magnetic field lines of the magnetic holding force generator pass.

This is useful because the flush surface contact between the coupling piece and the holding surface of the brake stator makes a high releasing force necessary to overcome the magnetic holding force, and thus serves to promote stable maintenance of the end position of the coupling piece.

The displacement of the coupling piece into both the unlocking position and the locking position can then be effected by a single force pulse in each case.

The force pulse is so defined in terms of duration and magnitude that the coupling piece reliably arrives at the particular intended end position and is then also held in that position.

In the holding position, of course, the force pulse ceases to act, and only the holding force of the magnetic holding force generator remains operative.

Short force pulses can be generated by electromagnetic coil bodies, which need be connected only briefly to a suitably configured electrical circuit.

A suitable current pulse serves to generate the particular desired force for displacing the coupling body, which force acts on the coupling body in a pulse-like manner and displaces it to the desired end position.

So that, in addition, any simultaneous driving of both coils, i.e., driving of the unlocking coil and the locking coil, does not cause any change in the current position of the coupling piece, it is proposed that the magnetic fields be of substantially equal magnitude, but have the effect of canceling each other out.

This can be achieved by means of a single coil assembly that contains both the unlocking coil and the locking coil.

In the exemplary embodiments, mutually separate coils are provided for unlocking and locking.

It can further be provided, e.g. for safety reasons, that the unlocking force generator is supplemented by an additional unlocking force generator by means of which the brakes can also be supplied with air, i.e. released.

The two unlocking force generators would thus act on the coupling piece independently of each other.

This also applies mutatis mutandis to a second locking force generator.

In one exemplary embodiment, the supplemental unlocking force generator or locking force generator, as the case may be, can be configured as a manual actuation means and thus includes a corresponding handle.

A single manual actuation means can also be provided for both directions.

Exemplary embodiments having these features are disclosed.

The connection between the manual actuation means and the coupling piece is usefully made via a linkage or preferably via a Bowden cable.¹ ¹ ‘Translator’s Note: We assume that the German word Bodenzug, which appears three times in this patent, is an error for Bowdenzug. Bowdenzug is “Bowden cable,” whereas Bodenzug translates—nonsensically in these instances—as “ground traction.”

If it is desired, further, to produce such a safety brake that has high holding forces despite having a small overall volume, it is proposed that the tooth system between the coupling piece and the brake motor be configured in the form of sawteeth possessing a steep flank in the holding direction of the brake rotor, while the tooth flank acting in the opposite direction can be shallow.

The steeper the steep tooth flank, the higher the holding forces obtained under low contact pressure forces.

That being said, the steep flanks should not deviate from the surface normals by more than 5 degrees.

The invention will be described in more detail below with reference to exemplary embodiments.

In the drawing:

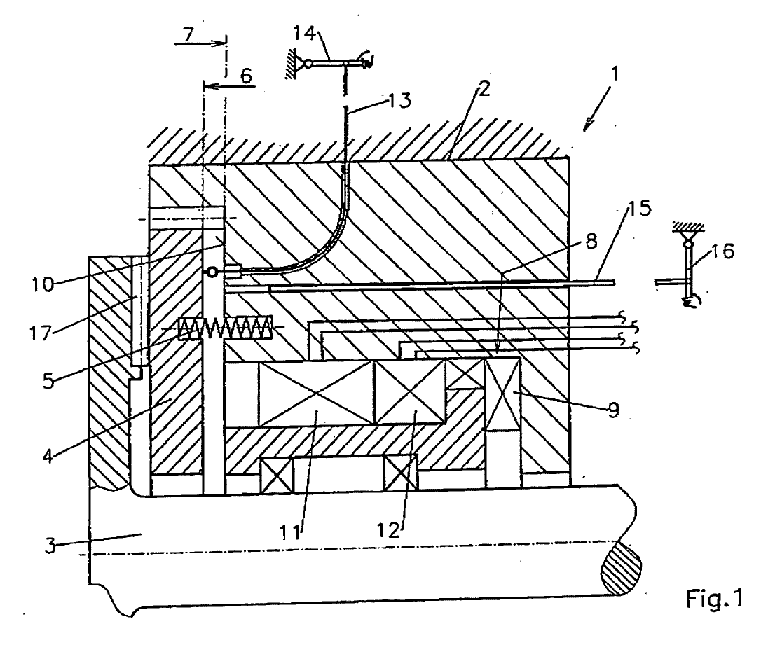

FIG. 1 is a schematic of the invention;

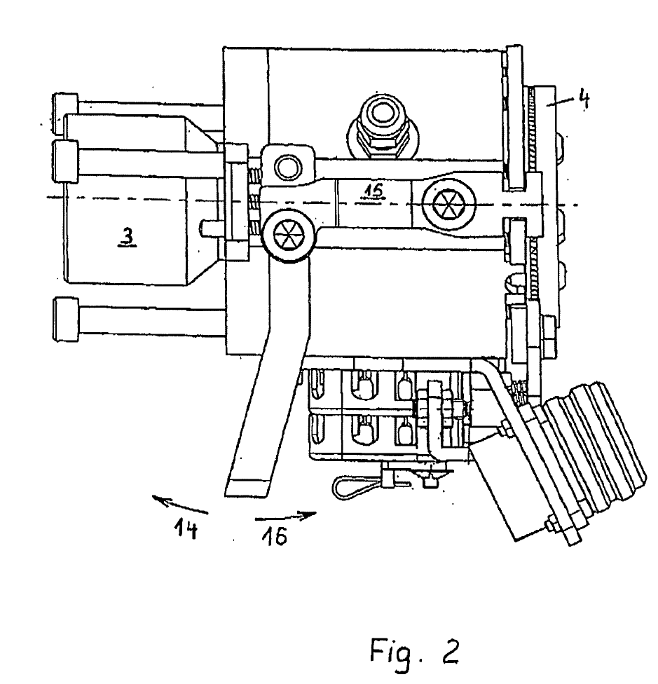

FIG. 2 is a side elevation of an exemplary embodiment with supplemental manual actuation means;

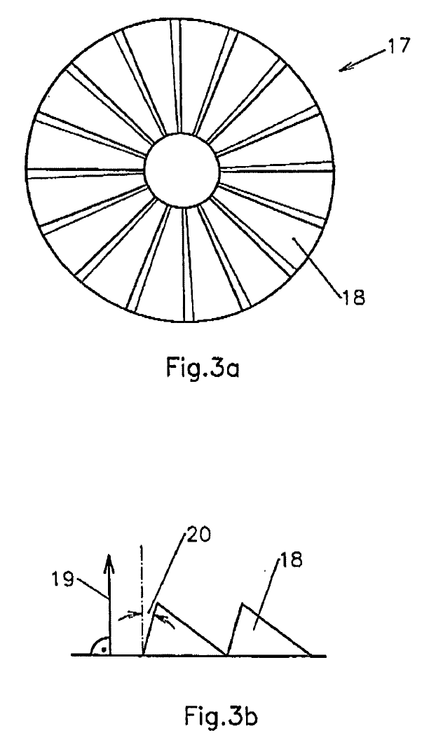

FIG. 3a depicts a tooth system;

FIG. 3b is a developed view of the tooth system according to FIG. 3a.

The following description applies to all the figures, unless otherwise stated below.

The figures show a safety brake 1 according to the present invention.

A brake rotor 3 is rotatably mounted on a brake stator 2.

A coupling piece 4 is [verb missing] between mutually corresponding surfaces of the brake rotor and the brake stator so as to be displaceable axially between a braking position 6 and a release position 7.

The coupling piece 4 is displaced into the braking position 6 by means of a preload spring 5 or a system of suitably arranged preload springs.

Under the force of these preload springs, the coupling piece 4 is displaced positively into the braking position 6 as soon as the brake is to be closed.

If, conversely, the coupling piece 4 is displaced from the braking position 6 to the release position 7, this occurs against the increasing restoring forces of the preload springs 5.

An essential feature is that the coupling piece 4 is held in the end position denoted as the release position 7 against the force of the preload spring 5 by a magnetic holding force generator.

The magnetic holding force generator 8 is integrated into the metallic housing of the brake stator 2 in such a way that the magnetic force lines it generates also pass through the coupling piece 4, which, like the brake stator 2, is made of magnetic material.

The magnetic holding force generator 8 thus exerts on the coupling piece 4 a magnetic attraction force that acts against the force of the preload springs 5, but is not sufficient to overcome the force of the preload springs 5.

This achieves the effect that the coupling piece 4 always remains in the braking position 6 if it is not urged in the other direction by a corresponding unlocking force.

The magnetic holding force generator 8 can be configured as an electromagnet.

In the case at hand, it is a ferromagnetic permanent magnet.

The permanent magnet 9 is configured here as a magnetic ring having an L-shaped profile and fixedly seated by its outer periphery in a corresponding bore in the brake stator.

If the coupling piece 4 is now displaced into the end position denoted as the release position 7, it butts, here, against a holding surface 10 through which the field lines of the magnetic holding force generator 8 pass.

This results in practically seamless contact between the coupling piece 4 and the holding surface 10, such that the strongest possible magnetic attraction force is obtained between coupling piece 4 and brake stator 2.

The coupling piece 4 is displaced from the braking position 6 to the release position 7 by an unlocking force generator 11, which is subjected to a corresponding pulse in such a way that a pulse-shaped unlocking force is applied to the coupling piece 4.

The unlocking force generator 11 in the present case is provided to be a so-called unlocking coil, which annularly and spacedly surrounds the brake rotor and is directly connected to the housing of the brake stator 2.

When the unlocking coil is briefly subjected to a voltage pulse, therefore, the coupling piece 4 moves toward the magnetic holding force generator 8 against the force of the preload springs 5.

The air gap between the coupling piece 4 and the permanent magnet 9 thus is appreciably diminished and the coupling piece 4 is drawn ever closer to the permanent magnet 9.

As a result of the areal abutment of the coupling piece 4 against the holding surface 10 of the brake stator 2, the coupling piece 4 thus reaches its other end position, denoted as the release position 7.

The coupling piece 4 is displaced into the previous end position, denoted as the braking position 6, by a locking force generator 12, which preferably also exerts only a pulse-like locking force on the coupling piece 4.

In the present case, the locking force generator 12 is a so-called locking coil, which can also be tied briefly into an electrical circuit.

As long as current is flowing through the coil, the latter generates a force pulse on the coupling piece 4 that acts in the direction of braking position 6 and is defined to be large enough to overcome the forces on the holding surface 10.

After this, the coupling piece 4 remains solely, i.e. predominantly, under the influence of the preload springs 5 and is displaced securely into the end position denoted as the braking position 6, which also can be denoted as the safety position of the safety brake.

If, in addition, those components of the magnetic fields of the unlocking coil and the locking coil that act on the coupling piece 4 are of substantially equal magnitude but of mutually canceling direction, the current position, the speed and the acceleration of the coupling piece 4 cannot be affected by the simultaneous operation of both electrical coils.

This, therefore, eliminates the possibility that a given position of the coupling piece 4 could be changed by the locking coil and the unlocking coil inadvertently being operated simultaneously.

This can be accomplished by having the unlocking coil and the locking coil belong to a single coil assembly equipped with a reversible-polarity circuit.

In the present case, however, the unlocking coil and the locking coil are two separate components, each connected into its own electrical circuit.

In addition, FIG. 1, together with FIG. 2, shows that two different unlocking force generators acting in parallel on the coupling piece 4 are provided to displace the coupling piece 4 from the braking position 6 to the release position 7.

The two unlocking force generators 11, 13 are independent of each other.

Provided here, in addition to the already described unlocking force generator 11, is a Bowden cable by means of which the coupling piece 4 can be released from the braking position.

This is usefully done by means of a suitable manual actuation means 14.

This also applies mutatis mutandis to a second locking force generator 15, by means of which the coupling piece 4 can be displaced from the end position denoted as the release position 7 back to the braking position 6.

A brief push on the coupling piece 4 is sufficient for this purpose, such that the force of the preload springs then serves to effect displacement all the way to the braking position 6.

Provided here as a supplemental locking force generator is a pressure pin that acts on the coupling piece 4 in a suitable manner.

Supplementarily, a separate manual actuation means 16 can also be provided here for the additional locking force generator.

Supplementarily thereto, FIG. 2 shows an exemplary embodiment in which a single manual actuation means is provided for both directions.

The safety brake is further configured in the present case as a toothed holding brake.

This means that a tooth system 17 whose teeth engage in one another in the braking position is provided between the coupling piece 4 and the brake rotor 3 or the brake stator 2, depending on the design.

The tooth system is configured here as a radially extending tooth system provided on corresponding annular surfaces of the brake rotor or of the coupling piece 4.

This is a so-called sawtooth system, in which the individual sawteeth have a shallow flank and an opposite steep flank.

In the direction of the shallow tooth flank, this toothed holding brake thus permits a certain ratchet function, while in the opposite direction of rotation of the brake rotor, the steep tooth flanks are opposite each other and therefore cause an appreciable braking function even when the force being exerted by the preload springs is still low.

The steep flanks of such sawteeth 18 should not deviate from the surface normals 19 by more than 5 degrees.

Such a safety brake, particularly in combination with tooth flanks configured in a sawtooth shape and extending radially in the form of a circular ring on the brake rotor, is particularly suitable for holding doors in railway cars, since an unauthorized opening movement is not possible because of the steep tooth flanks, whereas, conversely, the door will inevitably close via the ratchet function of the safety brake.

The small construction, with the reliable bistable positioning of the coupling body 4, is practically maintenance-free because of the permanent magnet used, and can also be produced and supplied in large quantities as a compact unit [syntax sic].

### LIST OF REFERENCE NUMERALS

1 Safety brake
2 Brake stator
3 Brake rotor
4 Coupling piece
5 Preload spring
6 Braking position
7 Release position
8 Holding force generator
9 Ferromagnetic permanent magnet
10 Holding surface
11 Unlocking force generator
12 Locking force generator
13 Second unlocking force generator
14 Manual actuation means
15 Second locking force generator
16 Manual actuation means
17 Tooth system
18 Sawtooth
19 Surface normal
20 Angle of deviation

What is claimed is:

1. A safety brake (1) comprising a brake stator (2), a brake rotor (3), and, provided between said brake rotor (3) and said brake stator (2), a coupling piece (4) biased in a direction toward a braking position (6) by a preload spring (5), and which is displaceable by magnet (8) from the braking position (6) against increasing spring force of the preload spring (5) to a release position (7), wherein said coupling piece (4) is held in the release position (7) by the magnet (8) against the force of the preload spring (5).

2. The safety brake (1) as in claim 1, wherein the magnetic (8) comprises a ferromagnetic permanent magnet (9).

3. The safety brake (1) as in claim 1, wherein in the release position (7), said coupling piece (4) abuts a holding surface (10) on said brake stator (2) and field lines of the magnet (8) pass through said coupling piece.

4. The safety brake (1) as in claim 1, wherein the displacement of said coupling piece (4) from the braking position (6) to the release position (7) is triggered by a pulse-like unlocking force delivered by an unlocking force generator (11), and the unlocking force is so defined in duration and magnitude that at the end of a pulse, said coupling piece (4) is predominantly under the force influence of the magnet (8).

5. The safety brake (1) as in claim 4, wherein to generate the pulse, the unlocking force generator (11) comprises an unlocking coil tied into a closable electrical circuit.

6. The safety brake (1) as in claim 5, wherein the displacement of said coupling piece (4) from the release position (7) to the braking position (6) is triggered by a pulse-like unlocking force delivered by an unlocking force generator (11) and is so defined in terms of duration and magnitude that at the end of the pulse, said coupling piece (4) is predominantly under the force influence of the preload spring (5).

7. The safety brake (1) as in claim 6, wherein to generate a locking force pulse, there is provided a locking force generator (12) comprising a locking coil tied into a briefly closable electrical circuit.

8. The safety brake (1) as in claim 7, wherein magnetic fields from said unlocking coil and from said locking coil are of substantially equal magnitude and of mutually canceling direction.

9. The safety brake (1) as in claim 7, wherein said unlocking coil and said locking coil comprise a single coil assembly tied into a reversible-polarity electrical circuit.

10. The safety brake (1) as in claim 1, wherein provided to displace said coupling piece (4) from the braking position (6) to the release position (7) are at least two unlocking force generators (11, 13) that act in parallel on said coupling piece (4).

11. The safety brake (1) as in claim 10, wherein said two unlocking force generators (11, 13) act on said coupling piece (4) independently of each other.

12. The safety brake (1) as in claim 10, wherein one of said two unlocking force generators (11, 13) comprises a manual actuation means (14).

13. The safety brake (1) as in claim 12, wherein provided to displace said coupling piece (4) from the release position (7) to the braking position (6) are at least two locking force generators (12, 15) that act in parallel on said coupling piece (4).

14. The safety brake (1) as in claim 13, wherein said two locking force generators (12, 15) act on said coupling piece (4) independently of each other.

15. The safety brake (1) as in claim 13, wherein one of said two locking force generators (12, 15) comprises a manual actuation means (16).

16. The safety brake (1) as in claim 12, wherein only one manual actuation means is provided for both directions.

17. The safety brake (1) as in claim 16, wherein said manual actuation means is connected to said coupling piece (4) by a Bowden cable.

18. The safety brake (1) as in one of claim 1, wherein a tooth system (17), whose teeth engage in one another in the braking position (6), is provided between said coupling piece (4) and a selected one of said brake rotor (3), and said brake stator (2).

19. The safety brake (1) as in claim 18, wherein the tooth system (17) is configured in the form of sawteeth (18), each having a shallow flank and, opposite thereto, a steep flank.

20. The safety brake (1) as in claim 19, wherein the steep flanks of said sawteeth (18) do not deviate (20) from the surface normals (19) by more than 5 degrees.
